(19) United States
(12) Patent Application Publication
(10) Pub. No.: US 2022/0188800 A1
(43) Pub. Date: Jun. 16, 2022

(54) CRYPTOCURRENCY PAYMENT AND DISTRIBUTION PLATFORM

(71) Applicant: New York Digital Investment Group LLC, New York, NY (US)

(72) Inventors: Patrick Sells, Arkadelphia, AK (US); Steven Schnall, New York, NY (US)

(21) Appl. No.: 17/687,284

(22) Filed: Mar. 4, 2022

Related U.S. Application Data
(62) Division of application No. 17/512,980, filed on Oct. 28, 2021.
Application No. 17/512,980 is a continuation of application No. PCT/US2021/071000, filed on Jul. 27, 2021.
(60) Provisional application No. 63/057,079, filed on Jul. 27, 2020.

(51) Int. Cl. G06Q 20/22; G06N 20/00; G06Q 20/06

(52) U.S. Cl. CPC G06Q 20/227; G06Q 20/065; G06N 20/00

(57) ABSTRACT

In embodiments of the present disclosure, a third-party cryptocurrency payment and distribution platform is provided that may facilitate the orchestration of fiat-to-cryptocurrency and cryptocurrency-to-fiat currency exchanges without necessitating a bank's direct involvement in the cryptocurrency transactions, but rather enables banks and other entities to provide access to cryptocurrency services for their customers through an external entity.

### CROSS-REFERENCE TO RELATED APPLICATIONS

This application claims priority to U.S. Provisional Patent Application 63/057,079, filed on Jul. 27, 2020. The above-identified application is hereby incorporated by reference as if fully set forth in its entirety.

### FIELD

The present disclosure relates to a cryptocurrency payment and distribution platform facilitating and orchestrating fiat currency payments and distributions, cryptocurrency currency payments and distributions, and mixed fiat and cryptocurrency payments and distributions.

### BACKGROUND

As cryptocurrencies such as Bitcoin become more commonplace and widely used among consumers, banks and other financial service providers are increasingly interested in making cryptocurrency services and products available to their customers as a way to increase customer retention and generate additional revenue (from, for example, fee income from cryptocurrency transactions). However, because of regulatory constraints, banks are currently limited in the types of cryptocurrency services they may directly provide, and access to cryptocurrencies remains challenging, such as requiring consumers and merchants to interact with unfamiliar systems and interfaces.

Therefore, there is a need for a third-party cryptocurrency payment and distribution platform that may facilitate the orchestration of fiat-to-cryptocurrency and cryptocurrency-to-fiat currency exchanges without necessitating a bank's direct involvement in the cryptocurrency transactions, but rather will enable banks and other entities to provide access to cryptocurrency services for their customers through an external entity.

### SUMMARY

Provided herein are methods, systems, services, modules, components and the like for a cryptocurrency payment and distribution platform (collectively referred to for convenience in some cases herein as “the platform”) that facilitate the orchestration of fiat-to-cryptocurrency and cryptocurrency-to-fiat currency exchanges and other banking, financial, and similar services. In embodiments, services are enabled without necessitating a bank's or a merchant's direct involvement in the cryptocurrency transactions. Similarly, banking and financial service elements involving non-cryptocurrency transactions, such as payments, loans, or other transactions denominated in fiat currency, may be facilitated by a traditional bank, without requiring cryptocurrency entities to become involved in complex and regulated activities. Instead, an external, intermediate entity may use or deploy the platform to orchestrate the distinct sets of cryptocurrency service elements and conventional banking or financial services elements by interacting with the native interfaces and systems of each. For example, in embodiments a consumer may interact with a merchant, such as to purchase goods or services, such as at a point-of-sale or electronic commerce store, wherein the consumer indicates through an interface a preference as to how to denominate the transaction, such as in fiat currency, cryptocurrency, or a combination of the two. The platform may receive an indicator of the preference and automatically orchestrate appropriate transfers, such that the merchant may be paid in its preferred denomination (e.g., dollars or cryptocurrency) and the cost of the goods or services to the consumer may be deducted from the appropriate type of account of the consumer (e.g., a bank or checking account or a cryptocurrency wallet). In embodiments, the platform may facilitate other transaction forms, such as allowing the consumer to borrow from a cryptocurrency account to fund the transaction with the merchant, allowing a user to receive payments (such as salary, benefits, insurance payouts, or the like) in a preferred denomination, or the like.

According to some embodiments of the present disclosure, an intelligent agent of the platform may be deployed to automate one or more of the functions of the platform, such as to automatically undertake a set of cryptocurrency service workflows, a set of banking or financial service workflows, or the coordination of an orchestration workflow across the sets of cryptocurrency services and banking or financial services. In embodiments, the intelligent agent may be trained, such as upon a training data set of outcomes, such as in a supervised, semi-supervised, or deep learning approach, to optimize orchestration, such as by providing a recommendation to a consumer or merchant (such as a recommendation as to the type of currency with which to pay or receive payment), by automatically optimizing the timing of service execution (e.g., trade timing, timing of borrowing, terms of borrowing, or the like) or other parameters or functions. In embodiments the intelligent agent includes, links to, or integrates with an artificial intelligence system, such as using a neural network, expert system, rule-based system, deep learning system, model-based system, or the like, or combination of the above.

In embodiments, the platform enables receiving transaction data from a set of data sources, where the transaction data includes account data that is received from a set of data resources that monitor a set of monitored physical entities associated with at least one financial account, the physical entity data transported by a set of network entities, and marketplace data streams generated by a set of marketplace assets, where the marketplace assets include at least a cryptocurrency market associated with the marketplace and a fiat currency market associated with the marketplace. The platform may further enable structuring the transaction data into a set of data structures that are configured to serve a transaction decision engine associated with a client application, receiving intelligent agent training data sets from the client application, each intelligent agent training data set indicating at least one respective transaction action taken by a user using the client application and one or more features that correspond to the respective transaction action, and training an intelligent agent on behalf of the user based on the intelligent agent training data sets, where the intelligent agent is configured to determine a transaction action to be performed on behalf of the user, where the determined transaction action includes a currency use recommendation for a transaction that is either recommended to the user using the client application or is automatically performed on behalf of the user.

In embodiments, the transaction undertaken by the user may be a product purchase, a purchase of a service, a receipt of a financial reward, a loyalty program redemption, or some other type of transaction.

In embodiments, the currency use recommendation is for the transaction may be conducted using fiat currency, cryptocurrency, or using a mix of fiat currency and cryptocurrency.

In embodiments, the transaction decision engine may use, include, process, and/or execute a model and/or a set of rules related to at least one of an account balance, a fiat currency valuation, a cryptocurrency valuation, a transaction value, a time of transaction, or some other type of financial indicator. The model and/or set of rules may be stored or otherwise embodied at least in part in a smart contract.

According to some embodiments of the present disclosure, a method is provided for configuring and initiating and orchestrating a cryptocurrency payment via the platform. The method includes identifying, by a processing system having one or more processors, a fiat account associated with a user, where the account is controlled by a financial service provider, identifying a cryptocurrency wallet associated with a user, where the wallet is controlled by the platform, identifying a cryptocurrency valuation, identifying a fiat currency valuation, receiving a request for payment from an entity, where the payment is for a product or service associated with the entity, withdrawing a cryptocurrency amount from the wallet, where the cryptocurrency amount corresponds to the request for payment based on the cryptocurrency valuation, exchanging the cryptocurrency amount for a fiat currency amount of corresponding value, and transferring the fiat currency amount to the entity to satisfy the request for payment.

In embodiments, the financial service provider may be a bank, a credit card company, a financial services company, or some other financial service provider type.

In embodiments, the exchange may be automatically performed by the platform based at least in a part on a rule stored in a smart contract. The rule may relate to a minimum cryptocurrency valuation to be met prior to making the exchange, a maximum cryptocurrency valuation, a range of cryptocurrency valuations, a fiat currency valuation (such as an exchange rate with one or more other forms of fiat or cryptocurrencies), an interest rate range, a transaction size (minimum, maximum, or range), a timing parameter (such as when the transfer should be executed), or the like.

According to some embodiments of the present disclosure, a cryptocurrency payment system is provided. The system includes a machine learning system that trains a set of machine-learned models to identify a set of transaction criteria for a financial transaction marketplace using a training data set comprising at least one of a cryptocurrency market, a financial service provider account, and transaction outcomes data, and an artificial intelligence system that receives a payment request as part of processing a transaction, where the payment request includes data relating to transaction criteria, an artificial intelligence system that matches the received transaction criteria to at least one set of transaction criteria among the set of machine-learned models, and an artificial intelligence system that makes a recommendation to fulfill the payment request in either fiat currency or cryptocurrency based in part on the matched set of transaction criteria among the set of machine-learned models.

In embodiments, the transaction criteria may include rules related to at least one of an account balance, a fiat currency valuation, a cryptocurrency valuation, a transaction value, or a time of transaction, or some other type of financial indicator.

According to some embodiments of the present disclosure, a platform is provided. The platform includes a first set of orchestration services for orchestrating interactions with a cryptocurrency wallet of a user, and a second set of orchestration services for orchestrating interactions with a set of interfaces of a bank that maintains a bank account of the user, where the first and second sets of orchestration services coordinate a set of transaction workflows via the cryptocurrency wallet and the interfaces of the bank whereby upon receipt by the platform of an indicator to use cryptocurrency for a transaction, a user's account holding cryptocurrency may be redeemed for an amount of fiat currency required for the transaction and a counterparty to the transaction may be paid the amount of fiat currency.

In embodiments, the user may provide the indicator to use cryptocurrency in a checkout interface of a merchant who is a counterparty to the transaction. The indicator to use cryptocurrency may be provided in response to a recommendation by an intelligent agent of the platform, or provided automatically by an intelligent agent of the platform, or provided based on learning from a data set of historical user payment behavior, or provided based on current marketplace information regarding at least one of an interest rate for borrowing and an exchange rate between cryptocurrency and fiat currency, and/or provided based on current marketplace information regarding at least one of a price of cryptocurrency, an interest rate for borrowing, and an exchange rate between cryptocurrency and fiat currency.

In embodiments, at least one of the first set of orchestration services or the second set of orchestration services may use robotic process automation that is trained based on a training data set of user interactions with the platform.

According to some embodiments of the present disclosure, a platform is provided. The platform includes a first set of orchestration services for orchestrating interactions with a cryptocurrency wallet of a user, and a second set of orchestration services for orchestrating interactions with a set of interfaces of a bank that maintains a bank account of the user, where the first and second sets of orchestration services coordinate a set of transaction workflows via the cryptocurrency wallet and the interfaces of the bank whereby upon receipt by the platform of an indicator to use cryptocurrency as collateral for a transaction, a user's account holding cryptocurrency used as collateral for borrowing an amount of fiat currency required for the transaction and a counterparty to the transaction is paid the amount of fiat currency.

In embodiments, the user may provide the indicator to use cryptocurrency as collateral in a checkout interface of a merchant who is a counterparty to the transaction, or provide the indicator in response to a recommendation by an intelligent agent of the platform, or provide the indicator automatically by an intelligent agent of the platform, or based on learning from a data set of historical user payment behavior, and/or based on current marketplace information regarding at least one of an interest rate for borrowing and an exchange rate between cryptocurrency and fiat currency.

In embodiments, at least one of the first set of orchestration services or the second set of orchestration services may use robotic process automation that is trained based on a training data set of user interactions with the platform.

Cryptocurrencies are now widely used for commercial transactions. User authorization keys for cryptocurrencies typically are stored in a wallet, which is a digital file that stores private signing keys so that they can be used to authorize a transaction, such as with a seller. When a consumer uses a cryptocurrency, such as for a payment mechanism, there is a need to access the consumer's wallet to enable a transfer. The wallet is typically configured to interact with an underlying blockchain, such as embodying a distributed ledger that represents a set of transactions involving the cryptocurrency, typically validated by a set of consensus algorithms (such as proof-of-work, proof-of-stake, or the like) that provide a degree of community trust in the validity of the cryptocurrency via a combination of cryptographic security and the activities of users in the community, such as miners who deploy computational resources to validate the blockchains. Wallets and smart contracts provide a degree of abstraction that allows users to avoid having to understand the complex programming mechanics of blockchains; however, they have their own challenges and complexities. There are several ways that a wallet may be implemented. Cloud wallets, paper wallets, hardware wallets, offline devices and multi-signature hot wallets are examples of such implementations. Each implementation has a unique set of interface requirements, which present challenges, in particular for users who are unfamiliar with the details of particular implementations, including ease-of-use challenges, scale challenges, and security challenges, among others.

Cloud wallets or network wallets are based on cloud or network storage technology. Organizations that conduct a significant number of cryptocurrency transactions often use cloud wallets. Although cloud wallets are easily accessible from the devices connected to the network, they are susceptible to online theft initiated by hackers or unscrupulous employees and owners of online wallets. As such, Internet security is paramount to these cloud wallets, presenting a significant challenge for institutions, such as traditional banks, that may not employ information technology staff members with the right set of experience and capabilities to securely interact with a wide range of cloud wallets having disparate interfaces and security requirements.

Paper wallets, which involve printing the user's cryptocurrency address and private keys on a piece of paper, are secure against malware including viruses, Trojan horses, and key loggers, as long as the cryptocurrency keys are generated with secure equipment. They are secure against online theft initiated by hackers or unscrupulous employees and owners of online wallets. However, they are difficult to set up, and are not secure against physical theft. In particular, it would be challenging for a corporate enterprise which buys and sells significant amounts of cryptocurrency on a daily basis to manage paper wallets.

Multi-signature hot wallets and services are platforms which hold and manage users' cryptocurrencies. These services make it easier to carry out secure transactions without the need to import private keys, thereby offering added features such as strong multi-factor authentication and online access. They are relatively easy to set up and maintain for individual users, but they are vulnerable to malware such as Trojan horse programs that are present within the browser at the time of creation. Moreover, a corporate enterprise which buys and sells significant amounts of cryptocurrency on a daily basis will incur large service fees to use these services.

An offline computer or device can be used as a cryptocurrency wallet. These devices are secure against malware, as long as the cryptocurrency keys are generated with secure equipment. They are secure against online theft initiated by hackers. Once set up, they are easy to maintain. However, this may be a more expensive solution than a paper wallet, since it needs a separate computer or device. As a result, the wallet will need to be backed up. Additionally, a corporate enterprise which buys and sells significant amounts of cryptocurrency on a daily basis will require access to some of its offline devices. However, offline devices are detached from the network connections, and thus, may not easily be used by the corporate enterprise when it needs to fulfill its demand for the cryptocurrencies.

An objective of the present disclosure is to describe a cryptocurrency wallet that offers the convenience and access of cloud wallets and the safety and security of offline devices. Accordingly, the present disclosure describes a system including a cloud wallet for storage of cryptocurrency and a vault for storage of offline devices. The system includes an artificial intelligence module with access to a database which stores entries associated with each device stored in the vault, for example the amount of cryptocurrency stored on each device. The artificial intelligence module can also monitor past transactions conducted by the entity and predict a future demand for cryptocurrency. In embodiments, based on a prediction or forecast of the future demand for cryptocurrency for the entity, the artificial intelligence module can instruct a robot to retrieve one or more offline devices and connect them to the system.

In one example embodiment, predicting the future demand may be based on a profile of users and/or current trends in the market.

Additional features and advantages will be set forth in the description which follows, and in part will be understood from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

A more complete understanding of the disclosure will be appreciated from the description and accompanying drawings and the claims, which follow.

### BRIEF DESCRIPTION OF THE DRAWINGS

The accompanying drawings, which are included to provide a better understanding of the disclosure, illustrate embodiment(s) of the disclosure and, together with the description, explain the principle of the disclosure. In the drawings:

FIG. 1 is a block diagram showing the cryptocurrency payment and distribution platform in relation to the markets of cryptocurrency, traditional financial service providers, insurance, and merchants.

FIG. 2 is a block diagram of an exemplary system for secure storage of cryptocurrency.

FIG. 3 is a block diagram of an exemplary cryptocurrency system.

FIG. 4 is a block diagram of an exemplary computing device in a cryptocurrency payment and distribution platform.

FIG. 5 shows an example cryptocurrency vault storing offline devices.

FIG. 6 shows an example of the system infrastructure for a payment system according to an example embodiment.

FIG. 7 shows an example database structure storing information by various entities to facilitate a transaction.

FIG. 8 shows an example flow chart for account creation using the cryptocurrency payment and distribution platform.

FIG. 9 shows an example flow chart for algorithms to transmit various data inputs and API calls in coordination with the cryptocurrency payment and distribution platform.

FIG. 10 shows an example flow chart for a payment transaction using the cryptocurrency payment and distribution platform.

FIG. 11 shows machine learning based processes incorporated in the cryptocurrency payment and distribution platform.

FIG. 12 shows an example flow chart for paying for a transaction using a cryptocurrency accrued in the form of a reward.

FIG. 13 shows example flow chart in which a machine learning model can be used to determine how much cryptocurrency may be used for a given transaction.

FIG. 14 shows an example flow chart for optimizing balances between cryptocurrency and fiat money using the cryptocurrency payment and distribution platform.

FIG. 15 shows example processes including algorithms to provide availability of fiat and/or cryptocurrency to facilitate a transaction.

FIG. 16 shows an example user interface for an application of a client device capable of interacting with the cryptocurrency payment and distribution platform.

FIG. 17 shows an example user interface for making a payment using the cryptocurrency payment and distribution platform.

FIG. 18 shows an example user interface for providing a user of the cryptocurrency payment and distribution platform with an option for adding fiat currency or cryptocurrency to the user's account or wallet.

FIG. 19 shows an example user interface for providing a user of the cryptocurrency payment and distribution platform with an option for funding the user's accounts.

To describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered limiting in scope.

### DETAILED DESCRIPTION

The present disclosure relates to a cryptocurrency payment and distribution platform 100 providing banks, financial service providers 118, insurers 124, retail and other merchants 128 or individuals the ability to accept payment and provide distributions, rewards and other consumer incentives in the form of fiat currency and/or cryptocurrency, or some blending or mixing of fiat currency and cryptocurrency in a single payment or distribution. This may allow such entities, such as merchants or individuals, to continue to accept payment in fiat currency while enjoying the benefits of traditional fiat banking systems and service providers 118, such as robust payment and credit platforms, but with the expanded ability to accept purchases and sales that are denominated for at least one of the counterparties in cryptocurrency, including automated cryptocurrency trades that are triggered, at least in part, by traditional fiat currency banking or merchant activities, as well as trades that involve borrowing fiat currency using cryptocurrency balances as collateral. The platform 100 as described herein provides users the ability to diversify their assets, for example by maintaining minimal or optimal balances of local fiat currency at their local bank to mitigate risk. As such, cryptocurrency may be transferred only when needed for financial expenditures.

In embodiments, the platform 100 may allow users who have balances in cryptocurrency to be able to spend it in real time, whenever, and wherever they want, which currently is not possible today. Government regulatory agencies have been concerned about losing control and about keeping bad actors, such as money launderers, out of the financial system. The platform of the present disclosure addresses this problem by requiring the users to maintain a bank account and not just a cryptocurrency account.

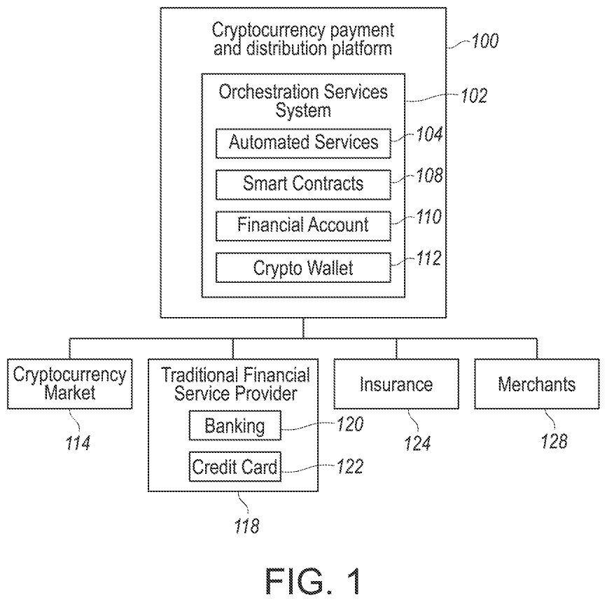

Referring to FIG. 1, the platform 100 may include an orchestration services system 102, including automated services 104 that may utilize smart contracts 108, and other mechanisms and services as part of managing a wallet, such as a cryptocurrency wallet 112 using the native interfaces (including application programming interfaces) and systems of the cryptocurrency wallet 112 and also managing a traditional financial account 110, such as a bank account 120 (checking, debit, savings, or other), credit card account 122, or money services business account, among others, using the native interfaces (including application programming interfaces) and systems of the traditional financial account. The platform may be further operated by, linked to, integrated with, or otherwise associated with cryptocurrency trading platforms, platforms of traditional finance entities, including but not limited to banks and credit card companies, insurers, retail or other merchants, or some other financial or transactional entity.

In embodiments, the platform 100 may include an orchestration services system 102 that may perform and optionally automated a variety of tasks or workflows involved in orchestration of transactions across the cryptocurrency wallet 112 environment and the traditional financial services environment, such as collection of marketplace information (such as exchange rates among currencies and cryptocurrencies, interest rates, and the like), collection of account information (such as account balances, settings, preferences, and parameters for rule-based processing (such as thresholds, ranges and the like)), intelligent order matching (e.g., of a purchase or sale of goods or services to a cryptocurrency balance transfer and/or fiat currency transfer), analytics tasks (such as a set of analytics on marketplace data and/or account data to provide a recommendation as to how a transaction should be denominated (such as in fiat currency, cryptocurrency or the like, or as a loan of fiat currency against a cryptocurrency balance)), data integration tasks and services (such as extraction, transformation, loading, normalization or other tasks required to enable the orchestration services system 102 to interact with the native application programming interfaces or other interfaces of the respective cryptocurrency wallet and financial services systems), automation tasks (such as automation of transaction execution, account reconciliation, reporting, or the like) and/or any other suitable tasks on behalf of the platform 100. The orchestration services system 102 may include machine learning, artificial intelligence, expert system, robotic process automation, and other capabilities, including use of neural networks, rule-based systems, model-based systems, and hybrids or combinations thereof, which may be trained, such as on tagged or labeled data sets (such as for classification or recognition tasks), on outcomes (such as financial outcomes, user satisfaction outcomes, or the like), and/or using supervised, semi-supervised, or deep learning. Methods. In embodiments, the orchestration services system 102 may include a machine learning system that trains machine learned models that are used by the various systems of the platform 100 to perform intelligence tasks, including predictions and forecasts, classifications, process control, monitoring of conditions, prescriptive analytics, and the like. In embodiments, the platform 100 may include an artificial intelligence system that performs various AI tasks, such as automated decision making, and the like. In embodiments, the platform 100 may include an analytics system that performs different analytics across cryptocurrency, banking 120, insurance 124, retail merchants 128, or other market data to identify insights related to the states of a cryptocurrency market 114 and fiat currency markets, accounts, balances, and the like. For example, in embodiments, the analytics system may analyze a current valuation of a cryptocurrency, an account balance, such as a cryptocurrency wallet, or the like with respect to a planned purchase, planned financial distribution, credit offering and the like to determine whether the planned financial activity should be in cryptocurrency, fiat currency or some blending or mixing of crypto and fiat currencies. In embodiments, the analytics system may perform the analytics in real-time as data is ingested from the various data sources to update one or more states of a financial marketplace or account. In embodiments, the intelligent orchestration services system 102 may include an orchestration automation system 104 that learns behaviors of a financial market and/or of respective users and automates one or more tasks on behalf of the users based on the learned behaviors. In some of these embodiments, the orchestration automation system 104 may configure intelligent agents on behalf of a financial marketplace such as a bank, credit card company, broker, insurer, retailer, merchant, or the like. The automation system may configure machine-learned models and/or AI logic that operate to generate outputs, such as ones that govern actions or provide inputs to other systems, given a set of conditions. In embodiments, the orchestration automation system 104 may receive training data sets of financial interactions by experts and configure the machine-learned models and/or AI logic based on the training data sets. In embodiments, the orchestration services system 102 may include a natural language processing system that receives text/speech and determines a context of the text and/or generates text in response to a request to generate text.

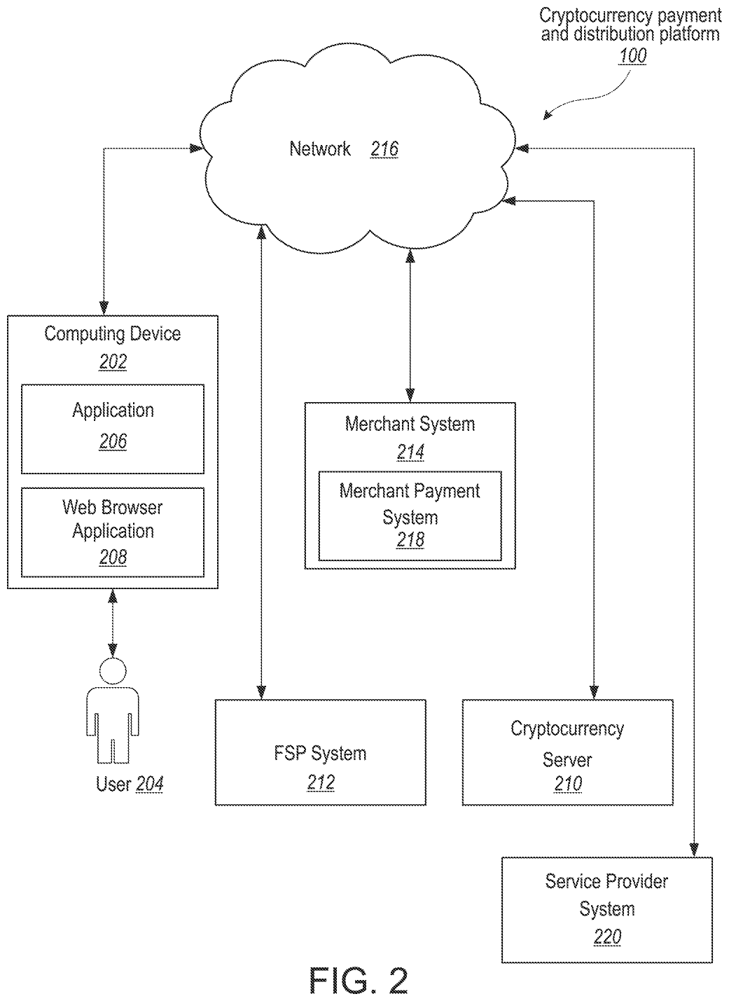

Referring to FIG. 2, in embodiments, the platform 100 may be configured for secure storage of cryptocurrency consistent with disclosed embodiments. As shown, the 100 may include a computing device 202 associated with a user 204. The computing device 202 may be configured to execute, among other programs, an application 206 for cryptocurrency transactions. The platform 100 may further include a cryptocurrency server 210, a financial service provider (FSP) system 212 and a merchant system 214. As shown in FIG. 2, the computing device 202, cryptocurrency server 210, FSP system 212 and merchant system 214 may be communicatively coupled by a network 216. While only one computing device 202, cryptocurrency server 210, FSP system 212 and merchant system 214 and network 216 are depicted in FIG. 2, it will be understood that the platform 100 may include more than one of any of these components. More generally, the components and arrangement of the components included in the platform 100 may vary. Thus, the platform 100 may include other components that perform or assist in the performance of one or more processes consistent with the disclosed embodiments.

In embodiments, the computing device 202 may be one or more computing devices configured to perform operations consistent with the application 206.

In embodiments, the application 206 may be one or more software applications configured to perform operations consistent with connecting to the cryptocurrency server 210, the FSP system 212 and merchant system 214 via the network 216. For example, the application 206 may be configured to place an order for transferring fiat currency (e.g., U.S. dollars) with the FSP system 212, an order for buying and selling cryptocurrency with the cryptocurrency server 210, and an order for buying a product with the merchant system 214. In one example embodiment, the application 206 may enable the user to convert cryptocurrency to fiat currency and/or convert fiat currency to cryptocurrency.

In an example embodiment, the computing device 202 may include a web browser application 208. The web browser application 208 may be one or more software applications configured to perform operations consistent with providing and displaying web pages, such as web pages associated with merchants and service providers. The web pages may include account login fields, transaction fields, shopping carts, dynamic information (i.e., information targeted to a specific user), or some other type of information.

In embodiments, the cryptocurrency server 210 may be one or more computing devices configured to perform operations consistent with storing cryptocurrency and performing cryptocurrency transactions. The cryptocurrency server 210 may be further configured to perform operations consistent with receiving data from the application 106 and transmitting signals to the application 206. The signals may be configured to cause the application 106 to display an account balance (or wallet balance, such as a digital cryptocurrency wallet) to the user or information sufficient to place a cryptocurrency order. Alternatively, or additionally, the cryptocurrency server 210 may be further configured to perform operations consistent with receiving information from the application 206 and to place an order. The cryptocurrency server 210 may also receive data from other sources and generate predictions about future demand for a cryptocurrency.

In embodiments, the FSP system 212 may be associated with a financial service entity that provides, maintains, manages, or otherwise offers financial services. For example, the financial service entity may be a bank, credit card issuer, or any other type of financial service entity that generates, provides, manages, and/or maintains financial service accounts for one or more customers. Financial service accounts may include, for example, credit card accounts, loan accounts, checking accounts, savings accounts, reward or loyalty program accounts, and/or any other type of financial service account known to those skilled in the art. The FSP system 212 may be one or more computing devices configured to perform operations consistent with maintaining financial service accounts, including a financial service account associated with a user 204. The FSP system 212 may be further configured to authenticate financial transactions associated with such financial service accounts. In particular, the FSP system 212 may be configured to authenticate financial transactions associated with a financial service account associated with a user 204. In some embodiments, the FSP system 212 may be further configured to maintain, such as using a database and related elements, a set of cryptocurrency accounts and/or wallets held by its users. The FSP system 212 may communicate with the cryptocurrency server 210 (and/or the application 206) based on the information stored in the database. In some embodiments, the FSP system 212 may be further configured to generate content for a display device included in, or connected to, a computing device 202, such as through a mobile banking or other application on a computing device 202 (e.g., application 206), such as a smart phone or other computing device. Alternatively, or additionally, the FSP system 212 may be configured to provide content through one or more web pages or online portals that are accessible by the computing device 202 over the network 216. In an example embodiment, the FSP system 212 may receive information from or transmit information to the cryptocurrency server 210. The disclosed embodiments are not limited to any particular configuration of FSP system 212.

While the cryptocurrency server 210 and the FSP system 212 are shown separately, in some embodiments the cryptocurrency server 210 may include or be otherwise related to the FSP system 212. For example, in some embodiments the facility of the cryptocurrency server 210 may be provided instead by the FSP system 212, or vice versa. Alternatively, or additionally, in some embodiments, the cryptocurrency server 210 may be included in, and/or be otherwise related to, any other entity in the platform 100 and/or a third-party not shown in the platform 100. Alternatively, or additionally, the cryptocurrency server 210 may be a standalone server. The cryptocurrency server 210 may take other forms as well.

In embodiments, the merchant system 214 may be one or more computing devices configured to perform operations consistent with providing web pages that are accessible by the computing device 202 over the network 216. For example, the web pages may be provided at the computing device 202 through a web browser application 208. In some embodiments, the merchant system 214 may be associated with a merchant that provides goods or services. Further, in some embodiments, the web pages may be online retail web pages through which a user 204 may engage in transactions to purchase the merchant's goods or services. Other web pages are possible as well. The disclosed embodiments are not limited to any particular configuration of merchant system 214.

In some embodiments, the merchant system 214 may include a merchant payment system 218. The merchant payment system 218 may be one or more computing devices configured to perform operations consistent with providing, such as within the web pages provided by the merchant system 214 and/or within another interface such as a point-of-sale and/or in-store checkout system, a merchant-provided payment process through which a user 204 may engage in transactions to purchase the merchant's goods or services. In some embodiments, the merchant payment system 218 may be provided by the merchant in connection with one or more financial service providers, such as the financial service provider associated with the FSP system 212 or another financial service provider. The payment process may, for example, be the same as or similar to MasterPass™, PayPal®, or Visa® Checkout. Other payment processes are possible as well.

In embodiments, the network 216 may be any type of network configured to provide communication between components of the platform 100. For example, the network 216 may be any type of network (including infrastructure) that provides communications, exchanges information, and/or facilitates the exchange of information, such as the Internet, a Local Area Network, Wide Area Network, wireless network (e.g., WiFi™ or Bluetooth™), near field communication (NFC), optical code scanner, virtual private network, or other suitable connection(s) that enables the sending and receiving of information between the components of the platform 100. In other embodiments, one or more components of the platform 100 may communicate directly through a dedicated communication link(s), which may include dedicated physical links, virtual links, or a combination thereof. It is to be understood that the configuration and boundaries of the functional building blocks of the platform 100 have been defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

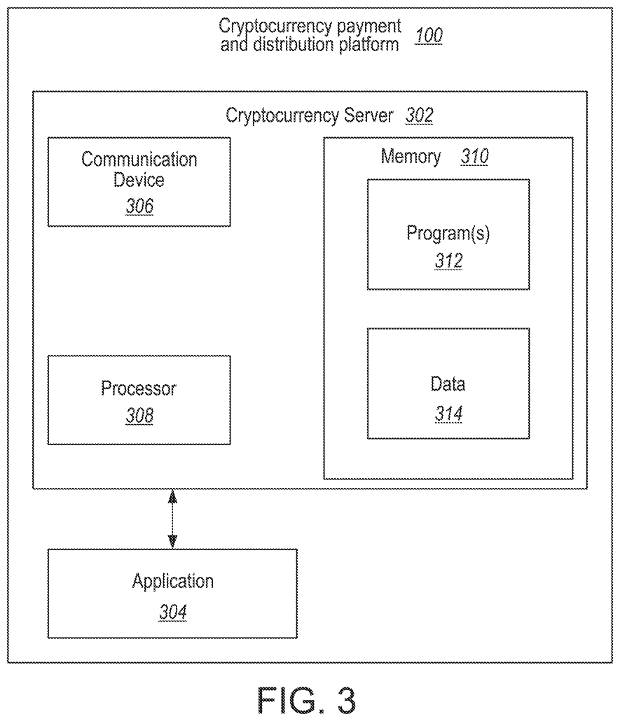

Referring to FIG. 3, in embodiments the cryptocurrency system 300 may include a cryptocurrency server 302 and a cryptocurrency application 304. The cryptocurrency server 302 may include a communication device 306, one or more processor(s) 308, and memory 310 including one or more programs 312 and data 314. The cryptocurrency server 302 may be configured to perform operations consistent with providing cryptocurrency application 304.

In embodiments, the cryptocurrency server 302 may take the form of a server, general purpose computer, mainframe computer, or any combination of these components. Other implementations consistent with disclosed embodiments are possible as well. The application 304 may take the form of one or more software applications stored on a computing device, such as a cryptocurrency application 206 stored on a computing device 202 as described herein.

In embodiments, the communication device 306 may be configured to communicate with one or more computing devices, such as the computing device 202. In some embodiments, the communication device 306 may be configured to communicate with the computing device(s) through the application 304. The cryptocurrency server 302 may, for example, be configured to provide to the application 304 one or more signals through the communication device 306. As another example, the cryptocurrency server 302 may be configured to receive from the application 304 data relating to a cryptocurrency transaction through the communication device 306. The communication device 306 may be configured to communicate other information as well.

In embodiments, the communication device 306 may be further configured to communicate with one or more FSP systems, such as the FSP system 212 described herein. In some embodiments, the FSP system may provide transaction data such as indicating parameters of a cryptocurrency buy or sale transaction, a loan transaction, or the like. The communication device 306 may be configured to communicate with the FSP system(s) in other manners. The communication device 306 may be configured to communicate with other components as well.

In embodiments, the processor(s) 308 may include one or more known processing devices, such as a microprocessor from the Core™, Pentium™ or Xeon™ family manufactured by Intel®, the Turion™ family manufactured by AMD™, the “Ax” (i.e., A6 or A8 processors) or “Sx” (i.e. S1, . . . processors) family manufactured by Apple™, or any of various processors manufactured by Sun Microsystems, for example. The disclosed embodiments are not limited to any type of processor(s) otherwise configured to meet the computing demands required of different components of the cryptocurrency system 300.

In embodiments, memory 310 may include one or more storage devices configured to store instructions used by the processor(s) 308 to perform functions related to disclosed embodiments. For example, memory 310 may be configured with one or more software instructions, such as program(s) 312, that may perform one or more analyses based on data provided by the cryptocurrency application 304 to determine whether a web page or other data element is or may be associated with illicit activity. For example, the program(s) may access a set of white lists, a set of blacklists (such as of entities or individuals designated as being banned from undertaking certain activities by law or regulation) and/or a set of pattern recognizers (such as a set of neural network or other artificial intelligence systems that are trained to recognize illicit content), or the like. In certain embodiments, memory 310 may store sets of instructions for carrying out the processes described below. Other instructions are possible as well. In general, instructions may be executed by the processor(s) 308 to perform one or more processes consistent with disclosed embodiments.

The components of the cryptocurrency system 300 may be implemented in hardware, software, or a combination of both hardware and software, as will be apparent to those skilled in the art. For example, although one or more components of the cryptocurrency system 300 may be implemented as computer processing instructions, all or a portion of the functionality of the platform 100 may be implemented instead in dedicated electronics hardware.

In some embodiments, the cryptocurrency system 300 may also be communicatively connected to one or more database(s) (not shown). Alternatively, such database(s) may be located remotely from the cryptocurrency system 300. The cryptocurrency system 300 may be communicatively connected to such database(s) through a network, such as the network 216 described herein. Such database(s) may include one or more memory devices that store information and are accessed and/or managed through the cryptocurrency system 300. By way of example, such database(s) may include Oracle™ databases, Sybase™ databases, or other relational databases or non-relational databases, such as distributed databases, Hadoop sequence files, HBase, or Cassandra. Such database(s) may include computing components (e.g., database management system, database server, etc.) configured to receive and process requests for data stored in memory devices of the database(s) and to provide data from the database(s). Data may also be stored in blockchain-based data storage systems, including distributed ledgers.

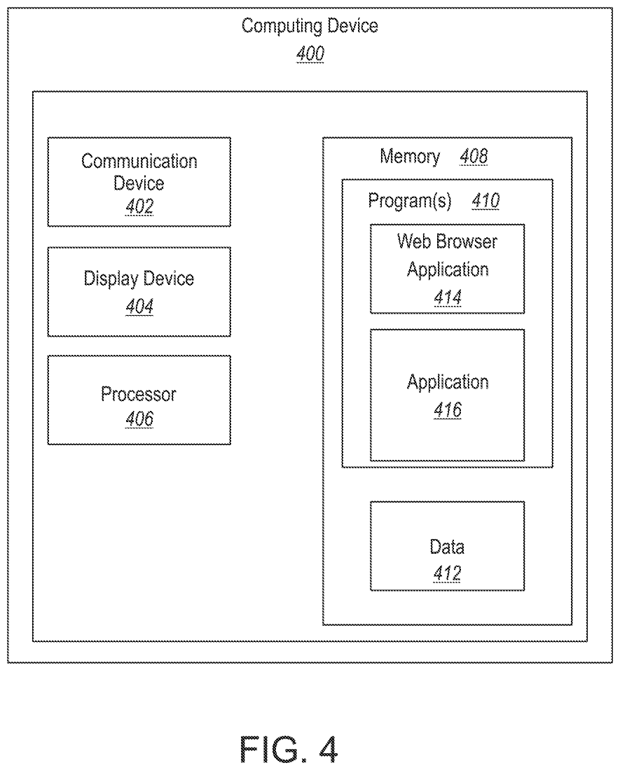

FIG. 4 shows a block diagram of an exemplary computing device 400, consistent with disclosed embodiments. As shown, the computing device 400 may include a communication device 402, display device 404, processor(s) 406, and memory 408 including program(s) 410 and data 412. Program(s) 410 may include, among others, a web browser application 414 and browser extension application 416.

In some embodiments, the computing device 400 may take the form of a desktop or mobile computing device, such as a desktop computer, laptop computer, smartphone, tablet, or any combination of these components. Alternatively, the computing device 400 may be configured as any wearable item, including a smart watch, jewelry, smart glasses, or any other device suitable for carrying or wearing on a user's person. Other implementations consistent with disclosed embodiments are possible as well. The computing device 400 may, for example, be the same as or similar to the computing device 202 described herein.

In embodiments, the communication device 402 may be configured to communicate with a cryptocurrency server, such as the cryptocurrency servers 210 and 302 described herein. In some embodiments, the communication device 402 may be further configured to communicate with one or more merchant systems, such as the merchant system 214 described herein, one or more FSP systems, such as the FSP system 212 described herein, and/or one or more service provider systems, such as the service provider system 220. The communication device 402 may be configured to communicate with other components as well.

In embodiments, the communication device 402 may be configured to provide communication over a network, such as the network 216 described herein. To this end, the communication device 402 may include, for example, one or more digital and/or analog devices that allow the computing device 400 to communicate with and/or detect other components, such as a network controller and/or wireless adaptor for communicating over the Internet. Other implementations consistent with disclosed embodiments are possible as well.

In embodiments, the display device 404 may be any display device configured to display interfaces on the computing device 400. The interfaces may include, for example, web pages provided by the computing device 400 through the web browser application 108. In some embodiments, the display device 404 may include a screen for displaying a graphical and/or text-based user interface, including but not limited to, liquid crystal displays (LCD), light emitting diode (LED) screens, organic light emitting diode (OLED) screens, and other known display devices. In some embodiments, the display device 404 may also include one or more digital and/or analog devices that allow a user to interact with the computing device 400, such as a touch-sensitive area, keyboard, buttons, or microphones. Other display devices are possible as well. The disclosed embodiments are not limited to any type of display devices otherwise configured to display interfaces.

In embodiments, processor(s) 406 may include one or more known processing devices, such as a microprocessor from the Core™, Pentium™ or Xeon™ family manufactured by Intel™, the Turion™ family manufactured by AMD™, the “Ax” or “Sx” family manufactured by Apple™, or any of various processors manufactured by Sun Microsystems, for example. Processor(s) 406 may also include various architectures (e.g., x86 processor, ARM®, etc.). The disclosed embodiments are not limited to any type of processor(s) otherwise configured to meet the computing demands required of different components of the computing device 400.

In embodiments, memory 408 may include one or more storage devices configured to store instructions used by processor(s) 406 to perform functions related to disclosed embodiments. For example, memory 408 may be configured with one or more software instructions, such as program(s) 410, that may perform one or more operations when executed by the processor(s) 406. The disclosed embodiments are not limited to separate programs or computers configured to perform dedicated tasks. For example, memory 408 may include a single program 410 that performs the functions of computing device 400, or program(s) 410 may comprise multiple programs. Memory 408 may also store data 412 that is used by program(s) 410. In certain embodiments, memory 408 may store sets of instructions for carrying out the processes described below. Other instructions are possible as well. In general, instructions may be executed by the processor(s) 406 to perform one or more processes consistent with disclosed embodiments.

In some embodiments, the program(s) 410 may include a web browser application 414. The web browser application 414 may be executable by processor(s) 406 to perform operations including, for example, providing web pages for display. The web pages may be provided, for example, via display device 404. In some embodiments, the web pages may be associated with a merchant system, such as the merchant system 214 described herein. The web browser application 414 may be executable by processor(s) 406 to perform other operations as well.

In some embodiments, the program(s) 410 may further include an application 416. An application 416 may, for example, be the same as similar to applications 206 and 304 described herein. An application 416 may be executable by processor(s) 406 to perform various operations including, for example, facilitate transfer of money or cryptocurrency transactions. Other instructions are possible as well. In general, instructions may be executed by the processor(s) 406 to perform one or more processes consistent with disclosed embodiments.

The components of the computing device 400 may be implemented in hardware, software, or a combination of both hardware and software, as will be apparent to those skilled in the art. For example, although one or more components of the computing device 400 may be implemented as computer processing instructions, all or a portion of the functionality of computing device 400 may be implemented instead in dedicated electronics hardware.

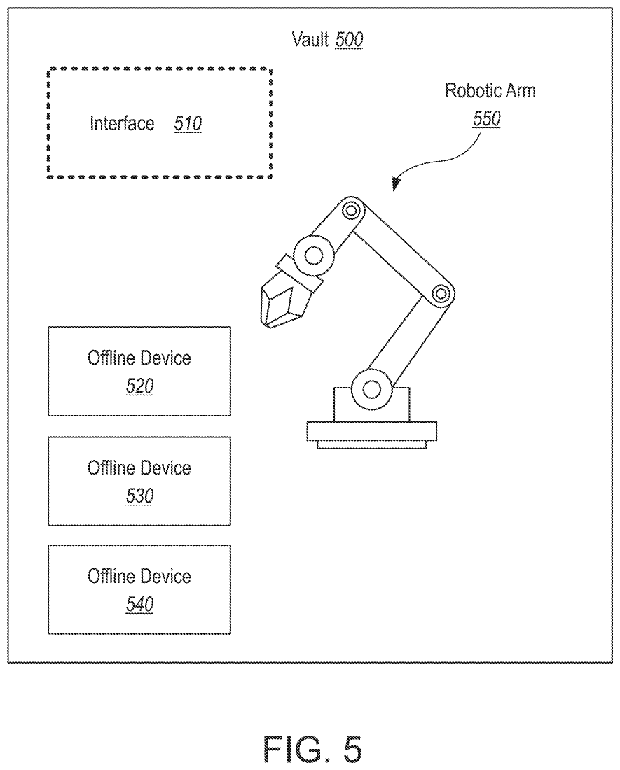

In one example embodiment, the cryptocurrency server 210 or 302 may include a cloud wallet for storage of cryptocurrency. The cryptocurrency server 302 can include an interface for connection to offline devices storing cryptocurrency. The interface can be a part of the communication device 306. These offline devices can be stored in a vault for security reasons. FIG. 5 shows an example vault storing offline devices. In this example embodiment, the vault 500 can be a secure storage location and house a plurality of offline devices 520-540. Each offline device can store cryptocurrency wallets thereon and can be connected to the interface 510. By connecting the offline device to the interface 510, the offline device can enable the cryptocurrency server 302 to receive access to the cryptocurrency wallets. In one example embodiment, the vault 500 can include a robotic arm 550. The robotic arm 550 can retrieve the offline devices 520-540 and connect them to the interface 550.

In one example embodiment, the cryptocurrency server can include a predictive model (or artificial intelligence module) which can instruct the robotic arm to retrieve a particular offline device and connect the device to the interface 510. The predictive model can make the determination based on a variety of factors. For example, the predictive model can have access to past transaction data, market trends, current user balances, orders placed by users, and other data. Based on this data, the predictive model can predict a future demand for a cryptocurrency. For example, the predictive model can determine that at a time in future there will a demand for selling a specific amount of cryptocurrency. The predictive model can also determine that the cloud wallets do not have sufficient funds to cover the required sale amount. As such, the predictive model can instruct the robotic arm to retrieve a sufficient number of offline devices and connect them to the interface prior to the time in future when the demand exceeds. The predictive model can make this determination based on the data entries stored in association with each offline device. These data entries can be stored on, e.g., memory 310. For example, the predictive model can select the offline devices based on how much cryptocurrency is stored on each device. Alternatively, each device can store an equal amount of cryptocurrency and the predictive model can select a number of the devices to meet the shortage.

In one example embodiment, the predictive model can manage a balance of cryptocurrency to avoid excessive storage of cryptocurrencies on cloud wallets. This can minimize the risk of any hacking or system attacks. For example, the predictive model can determine a current demand and a future demand for a cryptocurrency. Based on the current demand and the future demand, the predictive model can determine whether there is or there will be an excessive amount of cryptocurrency stored on the cloud wallets. Based on this determination, the predictive model can schedule for the robotic arm to move offline devices to the interface to store excessive cryptocurrency balance on the offline devices.

In embodiments, once an end user is enrolled in a cryptocurrency checking account (and/or saving account, money market account, deposit account, credit card account, debit card account, or any other account for holding assets) and in the mobile app associated with the platform 100, they may be presented with balances and payment options for currency (e.g., United States Dollars or “USD”), for cryptocurrency (e.g., Bitcoin or Ethereum), for a combination thereof and/or for a loan of one using the other as collateral. The end users may be able to then decide, in a pre- or post-transaction step, what form of currency they want to use to make a payment. The platform's 100 artificial intelligence model may present the user with various options or recommendations, such as based on a model, on a set of rules, or based on training, for example based on historical data and outcomes and based on current data and trends, as collected from marketplace data and/or account data, such as via APIs, via other interfaces and/or from communications among the entities involved. The various options for users present many optimization opportunities, which may be undertaken using a set of rules or a model (optionally embodied by a smart contract that facilitates transaction execution upon ingesting applicable data sets) or by an artificial intelligence system of the various types described herein. In one example embodiment, a set of default options may be provided for an account (e.g., for certain transaction types, merchant types, and the like). In embodiments, this may be implemented to any form of payment (e.g., POS, Wire, ACH, Check, ATM withdrawal, credit card payment, and so forth). For example, if USD is selected by a user, such as in a checkout system, the user may transact using that form of currency (i.e., make a payment using USD). However, if the user selects Bitcoin as the means by which to finance the transaction, the system may trigger an automated redemption request of a commensurate amount (based on a current exchange rate as determined by pinging an appropriate source of exchange rate information) of Bitcoin held in the user's Bitcoin wallet. When the user selects Bitcoin and completes the transaction, the platform redeems the Bitcoin for USD. Once the redemption of Bitcoin has been completed, a USD equivalent of the redeemed Bitcoin will be deposited back with the originating bank or the third-party financier. The corresponding payment transferred by conventional payment processing channels, such as by either a bank or third-party financier, to the merchant or other counterparty's account. Redemption and payment transfer may be timed in various orders and sequences by the orchestration services; for example, a transfer to a merchant may be made in advance of redemption, vice versa, or simultaneously. An intelligent agent or other aspect of orchestration services may optimize the timing, such as based on generation of a forecast of exchange rate, of user behavior or the like. For example, if Bitcoin is predicted to rise in price, redemption may be delayed for a period of time to reduce the impact of the transaction on the user's account balance. Thus, in effect, users can use Bitcoin to make purchases while the mechanics of the transaction among merchants, banks and other financial services providers still use fiat currency, thereby avoiding the complexity of programming entirely new workflows to address complexities of cryptocurrency wallets, smart contracts and/or blockchain interfaces. The merchant or receiving party may still receive the payment in fiat currency. In doing so, the platform 100 solves the problem of the merchant not being able to receive payments in cryptocurrencies.

In embodiments, the platform 100 may use a Layer 2 or second layer protocol, including but not limited to the Lightning protocol, to account for a plurality of transactions before such transactions are recorded to the blockchain for final settlement. For example, a plurality of platform 100 users may conduct merchant transactions that are ultimately to be settled using a cryptocurrency balance, such as Bitcoin, and these transactions may be noted using Layer 2 or Layer 3 protocols to record that the transactions are occurring, but the final disposition of recording the transactions to the blockchain for final settlement may be done in a single event, such as finalizing a full day of transactions at the end of the busines day. This may reduce computing capacity requirements, increase transaction processing speed (e.g., because each individual transaction does not need to be recorded to the blockchain in real-time), and reduce costs associated with the processing.

In embodiments, the platform's 100 artificial intelligence model, as described herein, may suggest advantageous ratios of cryptocurrency and fiat currency to be used for each transaction, such as based on a model and/or using learning on historical data sets representing cryptocurrency and fiat currency marketplace information, such as prices, volumes, interest rates, exchange rates, and the like. The model can be trained using past transaction data as well as current trends in the market and geolocation data. The artificial intelligence model may also recommend, using similar data, that the user borrow fiat currency using a cryptocurrency account balance as collateral. Recommendations may be based in part on user profiles, expressed preferences, and/or rules or settings (such as minimum balance amounts, maximum amount thresholds, credit limits, and the like).

The platform 100 disclosed herein has never been contemplated by banks, technology companies, or cryptocurrency companies because of the challenges for banks to interact with cryptocurrency for customers, including regulatory prohibitions and technical challenges. In some instances, a symbiotic relationship between banks and cryptocurrency companies has never been contemplated.

In an example, if the currency balance in the user's fiat account (e.g., a checking account holding USD) is greater than the cryptocurrency balance, a Bitcoin payment transaction can be fulfilled using the actual fiat money the merchant accepts. This decision can be guided by the system's artificial intelligence engine, which is capable of determining the appropriate ratios for fiat currency and cryptocurrency to be used for each transaction. The bank may charge a fee, such as between 2-3%, for this transaction, such as to cover fees for the redemption and margin.

In one example, if the user authorizes a transaction greater than the balance available in the user's checking account, the bank may contact a third-party financier to provide the funds for the transaction. The decision to contact the third-party financier may be guided by the system's predictive models. The third-party financier can facilitate the transaction and be paid back upon the redemption or selling of the Bitcoin. The third-party financier may charge fees, such as of around 5-7%, to enable this transaction. The third-party financier may have a fiat account at the bank that is linked to the user. The bank itself may also provide the linked account. The amount of fiat that could be spent above what is actually in the user's checking account may be determined by an algorithm that understands a user's bitcoin balance and ability to redeem that for fiat currency at a discounted rate to minimize price volatility in the redemption/settlement process.

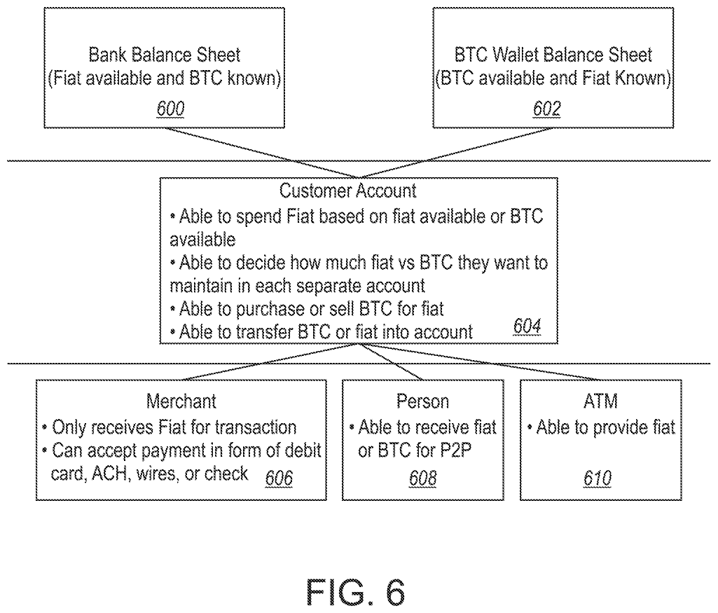

In embodiments, and as shown in FIG. 6, the platform infrastructure may include a payment system. In this example embodiment, the platform may be in communication with a bank, a third-party financier, a user, a merchant an ATM machine 610, or some other entity. The bank may maintain a fiat money balance 600 for the user and the third-party financier can have access to a user's digital wallet 602 and transfer/receive fiat money to/from the bank and customer account 604. In some embodiments, an entity separate from the third-party financier may hold the user's cryptocurrency wallet and the third-party financier may receive/send cryptocurrency from/to the wallet holder. The user, for example using an application of a client device or a debit card, may facilitate a payment using a combination of the fiat currency balance maintained in the user's account 604 and a cryptocurrency balance maintained in the user's wallet. The user may also initiate a payment to a merchant 606, for example using a wearable debit card, such as a ring, or withdraw money from an ATM machine 610. The payment or withdrawal may be financed by the fiat currency balance maintained in the user's account or the cryptocurrency balance maintained in the user's wallet. More specifically, the merchant may receive fiat currency for a transaction, and the user may finance the payment using cryptocurrency. The merchant may also receive a debit card, an ACH, wire transfer or check payment from the user. The user may facilitate the payment using a smart card, a client device or other means.

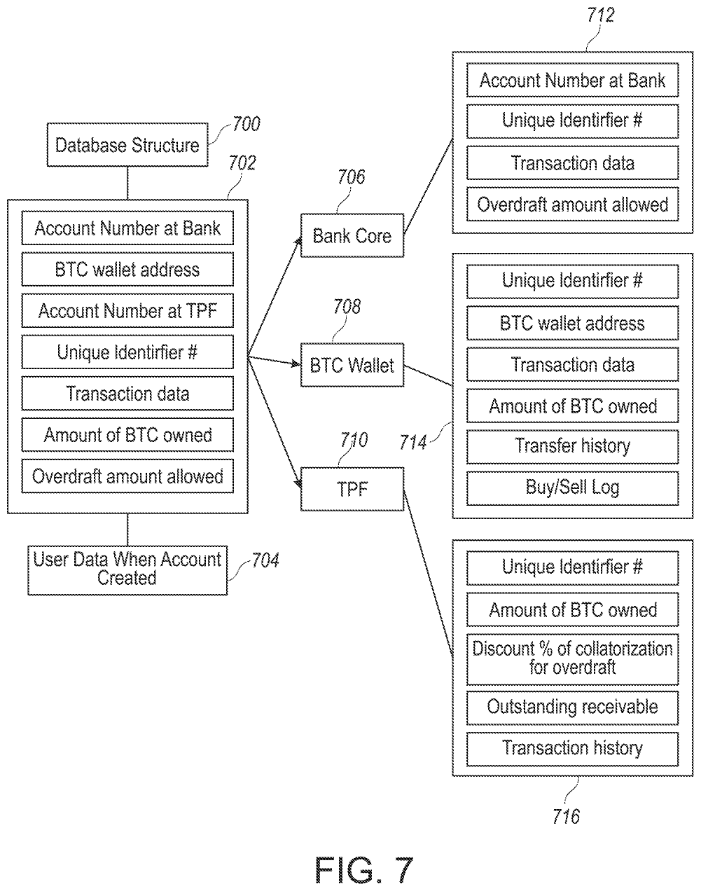

Referring to FIG. 7, an example database structure 700 is shown for storing information by various entities to facilitate the transaction in conjunction with the platform, as described herein. In this example embodiment, the bank 706 may store an account number 712, a unique identifier associated with the user 704, transaction data, and an indication of whether an overdraft protection may be allowed (or how it is implemented) 702. The entity maintaining the cryptocurrency wallet 708 may store the unique identifier 714, a digital wallet address, transaction data, an amount for each transaction, a transfer history and a buy/sell log. The third-party financier 710 may store the unique identifier 716, an amount of cryptocurrency owned, a discount rate of collateralization for overdraft (collateralization for the cryptocurrency allowance or an amount of fiat a user can spend beyond the actual fiat the user owns based on the algorithms used to determine how much cryptocurrency at any given point a user can spend), and outstanding receivables and a transaction history. One of ordinary skill in the art recognizes that these entities may maintain other information which can facilitate transactions. Additionally, one of ordinary skill in the art recognizes that although this example embodiment describes three separate entities facilitating the payment using a combination of fiat currency and cryptocurrency, other implementations in which two or more of these entities are combined are also possible.

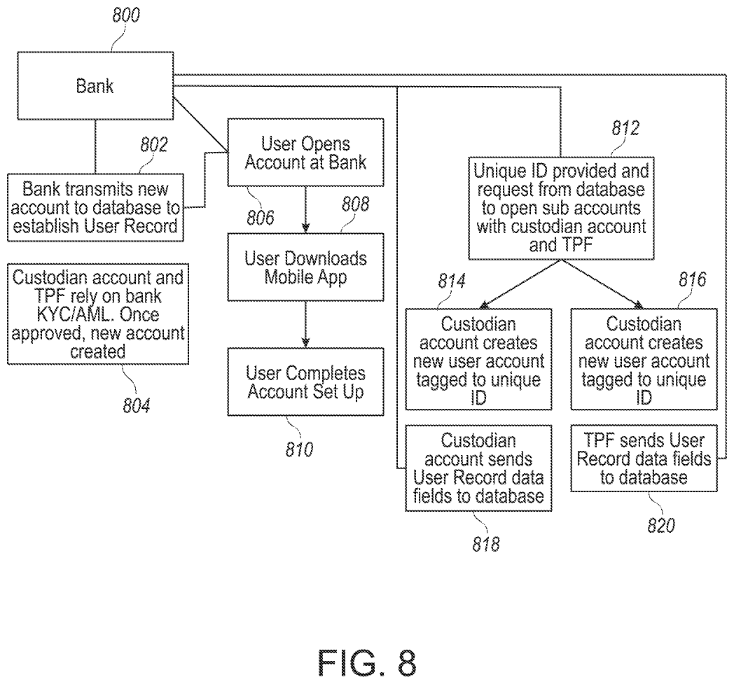

FIG. 8 shows an example flow chart for account creation using the platform according to an example embodiment. The flow chart shows one example algorithm that may be used to create the various accounts needed on behalf of a user that are then linked together. In this example embodiment, the user may initiate an account creation process 806 with a bank 800, which simultaneously triggers creation of an account with each of the bank 800, third-party financier and the cryptocurrency wallet holder, where the bank 800 or other party transmits the new account data to a database to establish the user record 802. For example, a user may download an application 808 associated with a bank 800 and initiate the process of creating an account 806 for the user at the application, for example by clicking on a sign up for an account button. The bank may receive the user's information, such as name, address, social security number, etc., and approve the user's request for creating an account. The Bitcoin wallet, custodian, and/or third-party financier may rely on the anti-money laundering and know-your-customer verification processes as part of creating a new account 804. The bank 800 may generate a unique ID for the user. Subsequently, the bank may transmit the relevant information including the unique ID to a third-party financier and a wallet holder or other custodian so that they create respective accounts for the user 812. Upon receiving the information, each of the third-party financier and the wallet holder and/or custodian may create an account in association with the unique ID, or plurality of accounts and IDs, for the user 814 and 816, for example a cryptocurrency wallet and financing account, and transmit information relating to the accounts back to the bank 800 and provide user record data fields to a database associated with the bank 800 and/or platform 100.

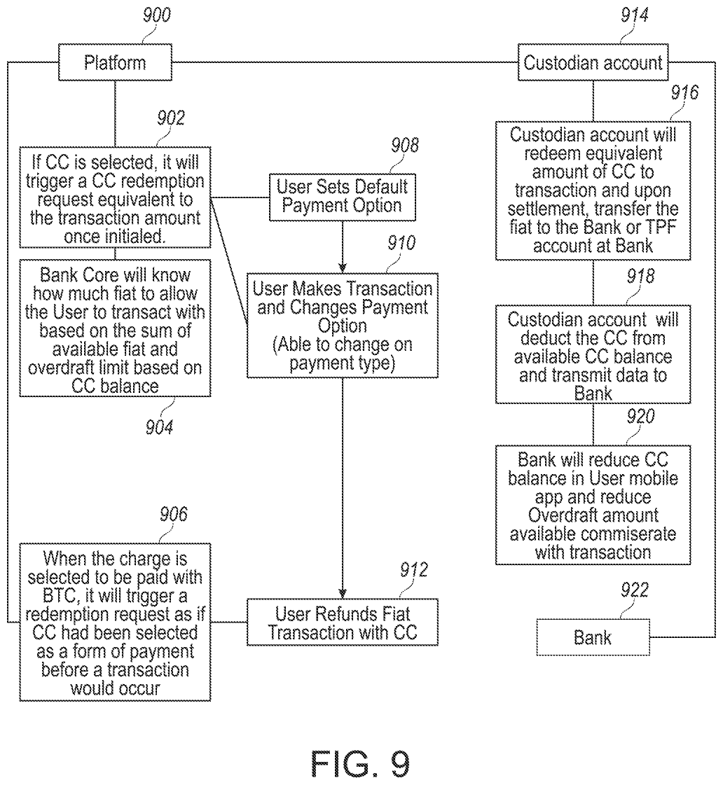

Referring to FIG. 9, an example flow chart is shown for algorithms that may be used to transmit data inputs and API calls associated with the platform 100 and 900, as described herein. This figure relates to a transaction in which the default payment option is payment by a cryptocurrency. In this example embodiment, in an application of a user's client device, the user can select cryptocurrency as the default payment 908. Once the user requests a payment, for example swiping a debit card, the bank may trigger a cryptocurrency redemption request to the cryptocurrency wallet holder 902. The bank can determine the cryptocurrency transaction amount based on various factors 904. For example, the amount can be based on the cryptocurrency balance of the user's cryptocurrency account. If the user's balance falls below a threshold (as dynamically determined by a machine learning model), the bank may adjust the amount based on an outcome of the machine learning model. When the charge is selected to be paid with a cryptocurrency, such as Bitcoin, this may trigger a redemption request as if cryptocurrency had been selected as a form of payment before a transaction would occur 906. Following this, the user may refund a fiat-based transaction with cryptocurrency 912. In embodiments, a Bitcoin wallet and/or a cryptocurrency custodian 914 may redeem an equivalent amount of cryptocurrency for the transaction upon settlement and transfer of the fiat currency to the bank 922 or third-party financier or other account 916. The Bitcoin wallet and/or a cryptocurrency custodian may deduct the cryptocurrency from an available cryptocurrency balance and transmit related data to the bank 918, whereupon the bank 922 may reduce the cryptocurrency balance in the user's mobile application and reduce the overdraft amount available by an amount commiserate with the transaction 920.

The bank may finance the rest of the payment using fiat currency stored in the user's checking account. In this example, the fiat currency may be provided by either the bank or the third-party financier in a linked account at the bank to the user. As another example, if the balance of the cryptocurrency wallet exceeds another threshold amount, the transaction amount can be equal to the fiat currency amount for the transaction.

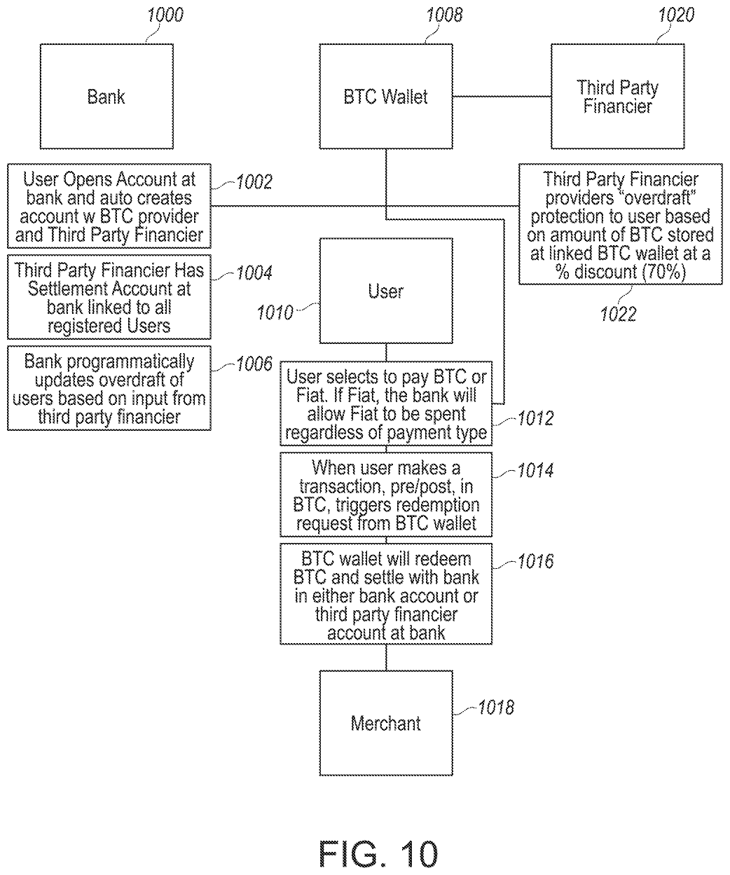

FIG. 10 shows an example flow chart for a payment transaction using the platform 100 according to an example embodiment. In this example embodiment, a user may open an account with a bank, which may in turn trigger opening accounts with a third-party financier and a wallet holder. The user may initiate a fiat currency payment transaction funded by a cryptocurrency on the user's application. This transaction may be initiated by the user's client device, debit card or wearable debit card. The request may be received at the user's bank. The bank may relay the request to the third-party financier and the user's wallet holder. In response, the wallet holder may transfer an amount of cryptocurrency to an account of the third-party financier. Upon receipt of the cryptocurrency, the third-party financier may transfer a sum of fiat currency to an account associated with the bank. Upon receipt of the funds, the bank may authorize the payment. Still referring to FIG. 10, in an example, a bank 1000 may receive a request from a user 1010 to open an account which also automatically creates an account in a Bitcoin wallet 108 and/or cryptocurrency custodian account and/or a third-party financier 1002. The third-party financier 1020 may have a settlement account at the bank 1000 that is linked to registered users 1004. The bank may programmatically update overdrafts of user based in part on input from the third-party financier 1006. Bitcoin wallet 1008 and/or cryptocurrency custodian account associated with the user 1010 may allow the user to select to pay in Bitcoin or some other cryptocurrency type or to pay in fiat currency. If fiat currency is selected the bank 1000 may allow the fiat currency to be spent by the user 1010 regardless of a payment type 1012. When the user makes a transaction in a cryptocurrency, this may trigger a redemption request from the Bitcoin wallet 108 and/or cryptocurrency custodian account 1014. The Bitcoin wallet 108 and/or cryptocurrency custodian account may redeem the Bitcoin, or other cryptocurrency type, and settle with the bank 1000 in either a bank account and/or a third-party financier 1020 account at a bank, or some other account type 1016. The merchant may receive the currency selected for the purchase of a good or service or other transaction type as an outcome of this process 1018. A third-party financier may provide overdraft protection to the user 1010 based at least in part on the amount of cryptocurrency, such as Bitcoin, that is stored at the linked Bitcoin wallet 108 and/or cryptocurrency custodian account 1022. The amount of overdraft protection provided may be at a percentage discount relative to the balance held by the Bitcoin wallet 108 and/or cryptocurrency custodian account.

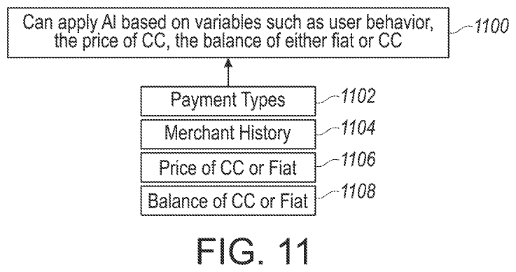

Referring to FIG. 11, machine learning processes 1100 are shown that may be incorporated in the platform, as described herein. For example, the system may include a predictive model for making predictions based on variables such as user behavior, payment types available 1102, merchant data, such as merchant history 1104, the price of cryptocurrency 1106, and/or the balance of either fiat or cryptocurrency 1108. In one example, the predictive model may determine a payment type. For example, based upon the users' transaction history, the predictive model may recognize that certain types of payments should be paid with fiat currency and other types should be paid with cryptocurrency; for example, a wire transfer may be cryptocurrency-funded whereas a peer-to-peer payment could be fiat currency-based. The system may auto-swap the currency selection based on the predictions of the model or prompt the user to confirm. As another example, based upon the users' previously defined payment selections for certain merchants, the platform may automatically adjust and/or predict the user's selection for certain transactions before or after a purchase is made. As another example, the system may take into account the user's location in predicting the combination of fiat currency and cryptocurrency to use when making a payment. For example, the system may determine that a user is at a gas station and the preference is fiat currency at gas stations. The system may auto adjust the transaction or prompt the user to confirm. In another example, the platform may take into account the relative value of cryptocurrency and fiat currency and determine the ratio of each used to fund a transaction. For example, the system may determine that a relative value of a currency type has gone up, and thus, would fund a transaction with the currency that has increased in value to best maximize the value for the user. In particular, if cryptocurrency exchange rates are lower than the past three months' averages, it may suggest using fiat currency or vice versa. The system may also suggest refunding previous fiat transactions with cryptocurrency based on the increase in value of cryptocurrency to reduce the true net cost of the transaction. In another example, the platform may consider the current balances a user has in either cryptocurrency or fiat currency and automatically adjust to whatever form of payment should be used for a transaction to minimize transaction fees or negative balances. The platform may also take into considerations all other factors such as the price of cryptocurrency, the merchant history, and preferred payment methods to best optimize a transaction.

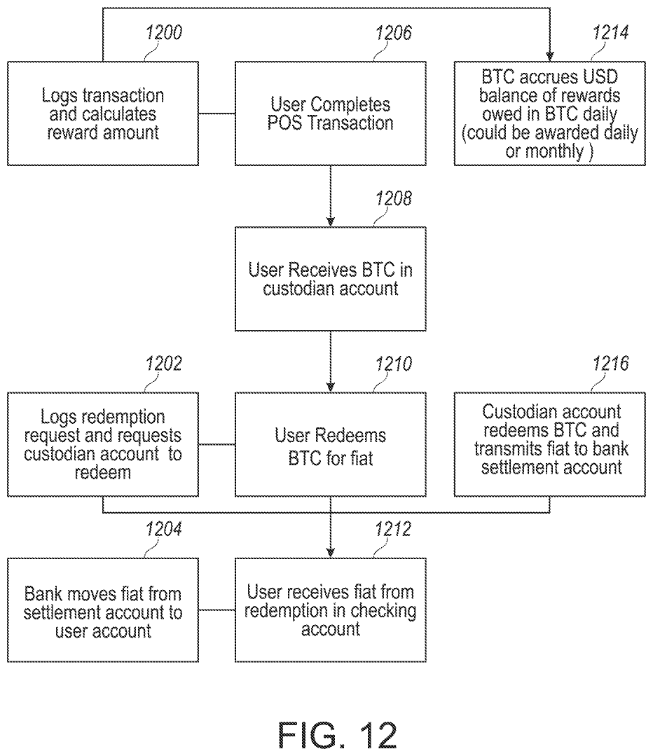

FIG. 12 shows an example flow chart using the platform 100 to pay for a transaction using a cryptocurrency accrued in the form of a reward. In this example, a user may use the user's debit card (or client device) in various purchase transactions. The bank may calculate a reward amount owed to a user based on a transaction amount or type and instruct a third-party financier to transfer an amount of cryptocurrency equal to the reward amount owed to the user. As a result, the user may receive rewards in the form of a cryptocurrency stored in a digital wallet associated with the user. Subsequently, the user may submit a request for redemption of the cryptocurrency on an application associated with a bank. In response, the bank may transmit a signal to the wallet holder to transmit an amount of cryptocurrency to an account of a third-party financier. Upon receipt of the cryptocurrency from the user, the third-party financier can transfer to an account associated with the bank a cash amount equivalent to the cryptocurrency received by the third-party financier. In response, the bank may transfer the cash amount to the user's account or facilitate a payment on behalf of the user. Still referring to FIG. 12, in an example, the platform 100 may log a transaction and calculate a reward amount 1200 that is associated with an action taken by a user, including but not limited to a purchase. The user may complete a transaction at a point-of-sale 1206, which may be an in-store purchase in a brick-and-mortar merchant establishment, an online merchant establishment, or some other transaction location. Bitcoin, or some other type of cryptocurrency, may accrue as a means of reward owed the user, for example that which has accrued on the basis of purchases made at merchants using fiat currency and/or cryptocurrency 1214. The user may receive Bitcoin or some other type of cryptocurrency in a Bitcoin wallet and/or cryptocurrency custodian account 1208. The platform 100 may log a redemption request at some point following the reward and submit a redemption request to the Bitcoin wallet and/or cryptocurrency custodian account 1202. The user may then redeem Bitcoin or some other type of cryptocurrency for a fiat currency amount 1210. The Bitcoin wallet and/or cryptocurrency custodian account may then redeem the Bitcoin or other cryptocurrency and transmit the fiat currency to a bank settlement account, or some other type of account 1216. The bank may move the fiat from the settlement or other account to an account associated with the user 1204. The user may then receive fiat currency from the redemption in a checking account, savings account, or some other type of financial account that is associated with the user 1212.

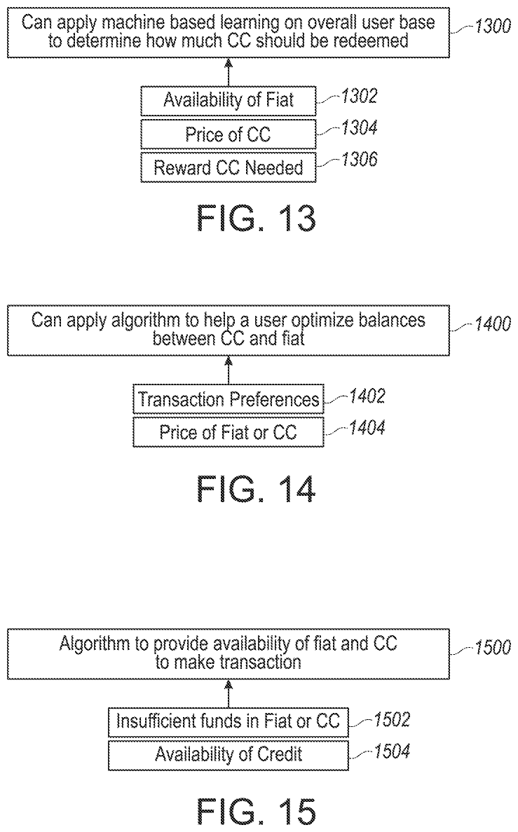

FIG. 13 shows an example flow chart in which a machine learning model 1300 of the platform 100 may be used to determine how much cryptocurrency needs to be used for a given transaction. In an example, the platform may use machine learning to evaluate a user's transaction history of cryptocurrency and factor in the price of cryptocurrency 1304 as well as its current trends to determine how much cryptocurrency should be redeemed in a particular transaction. In another example, the platform may use machine learning 1300 to determine fiat funding requirements for a future period of time, and thus, cutting down on the potential settlement time, cryptocurrency price risk, and fiat availability. As another example, the platform may use machine learning 1300 to factor in the availability of fiat currency 1302 and/or current price of cryptocurrency 1304 and/or the price trend of cryptocurrency to determine if it could optimize the price of cryptocurrency and either redeem user's cryptocurrency to fund a fiat transaction or provide a third-party funder or bank fiat in lieu of an actual cryptocurrency redemption in order to maximize or monetize the value of the cryptocurrency owned. As another example, the platform may use machine learning to factor in how much cryptocurrency would be needed in a given time period to determine how much cryptocurrency it will likely need to reward users based on point-of-sale transaction history. The platform may then factor the need against the expected redemption and the current price of cryptocurrency to determine how to best maximize the value of the cryptocurrency and rather to hold, transfer, or redeem cryptocurrency to meet fiat and cryptocurrency rewards needs.

FIG. 14 shows an example flow chart for using the platform 100 to optimize balances between cryptocurrency and fiat currency. In an example, the platform may use an algorithm 1400 to determine a user's purchase behavior trends including the amount spent and the fiat or cryptocurrency preference 1402 as well as the price of fiat or cryptocurrency 1404 to optimize the balances a customer maintains in cryptocurrency or fiat. For example, if the algorithm 1400 determines that Tuesdays have a much lower average total spend and the price of cryptocurrency is rising, it may auto-optimize balances of fiat and cryptocurrency to enable the user to maximize the increasing value of cryptocurrency and a minimal need for fiat availability. In another example, the platform 100 may use an algorithm 1400 to determine a user's average transaction history in comparison to the increasing or decreasing value of cryptocurrency to optimize the balances in either form (fiat or cryptocurrency) of currency, thus enabling the user to protect against volatility in either currency while minimizing the likelihood of transaction fees based on the availability of cryptocurrency or fiat in the user's wallet.

FIG. 15 shows example processes including algorithms 1500 used by the platform 100 to provide availability of fiat and/or cryptocurrency to facilitate a transaction. In an example, the platform may use an algorithm to provide a total “available” balance and/or credit 1504 to a user for transactions regardless of the default or selected form (fiat or cryptocurrency) of payment. For example, a user may have selected fiat and only has and insufficient amount 1502, for example $1,000 available on a purchase that requires $2,000. If the user has available cryptocurrency in excess of the difference, the system may enable the user to spend both forms of currency; first using the available fiat and then triggering a redemption request of cryptocurrency to cover the rest of the transaction. In another example, the system can use an algorithm that can combine the available fiat, available cryptocurrency, and available fiat credit extended to user and to best optimize the price of a transaction. The algorithm may be set to default to maximize or provide the user with a prompt to confirm the decision. The algorithm may take into account the price of the cryptocurrency, the cost of different forms of transactions, and the cost of available credit to determine the optimal composition of the needed payment amount to enable the transaction.

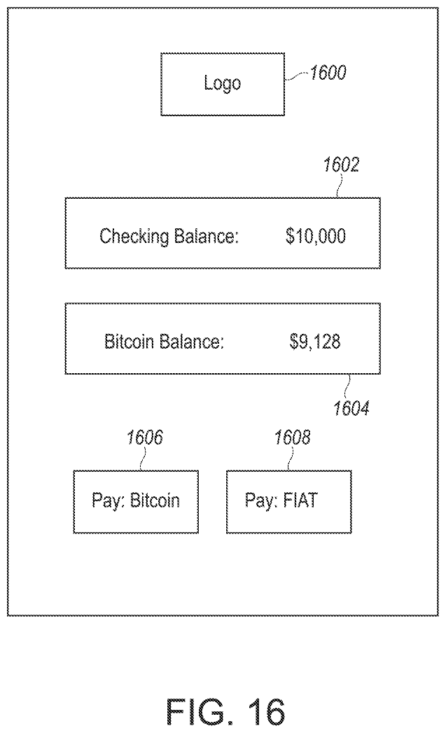

FIG. 16 an example of a page of a user interface for an application of a client device capable of interacting with the platform, as described herein. In this example embodiment, upon logging in, the user may see a logo 1600, such as a bank logo, a balance of a checking account 1602 holding fiat currency (or any other type of account doing same), and the user's balance in a cryptocurrency wallet 1604. The checking account balance may be provided by a bank and the cryptocurrency balance may be provided by a third-party financier or a wallet holder. The user may further be provided with an option (or button) to pay for a transaction using the checking account balance using fiat currency 1608 and another option (or button) to pay for the transaction using the cryptocurrency balance 1606.

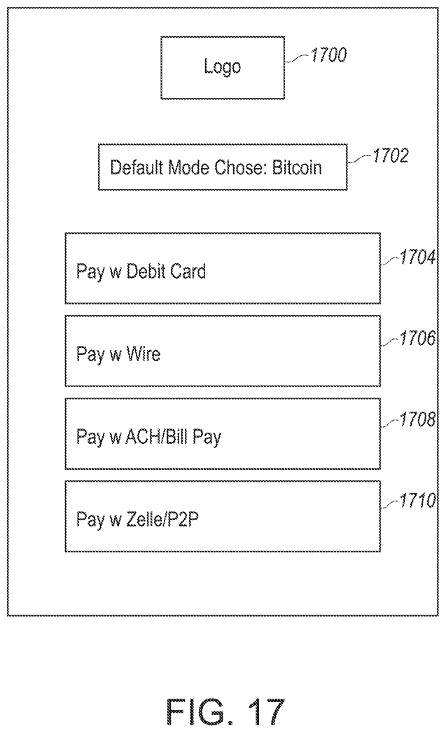

FIG. 17 shows an example of a page of a user interface for an application of a client device capable of interacting with the platform 100, as described herein. In this example embodiment, the user may have selected an option for making a payment, and as a result, the page displayed may present the user a logo 1700, such as a bank logo, and allow the user to select a payment option 1702, such as paying in Bitcoin, or some other cryptocurrency, or fiat currency. For example, a button may be provided for initiating a payment with a debit card 1704, a wire payment 1706, a peer-to-peer means of payment 1710, and/or an ACH/Bill payment 1708, which may be originated from the bank. The user may also initiate a payment with a third-party payment application. Additionally, there may be an option for payment using a cryptocurrency. The cryptocurrency balance may be maintained with a third-party financier or a cryptocurrency wallet holder. In an example embodiment, the option for payment with a cryptocurrency may be selected as the default option.

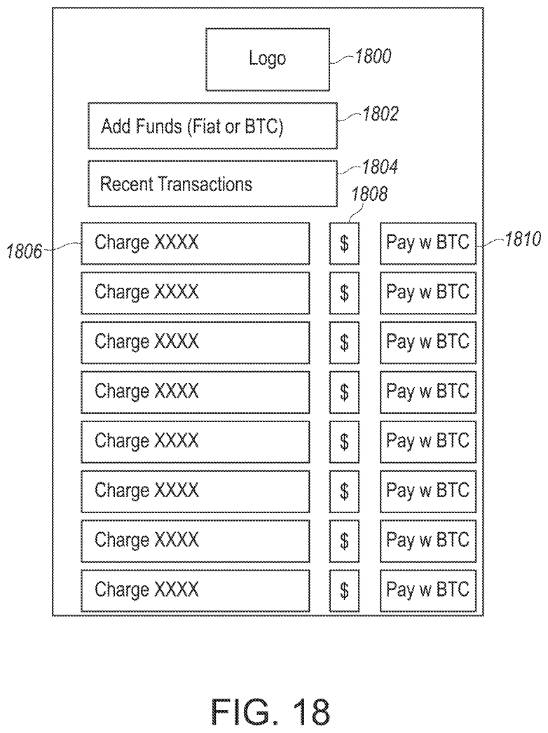

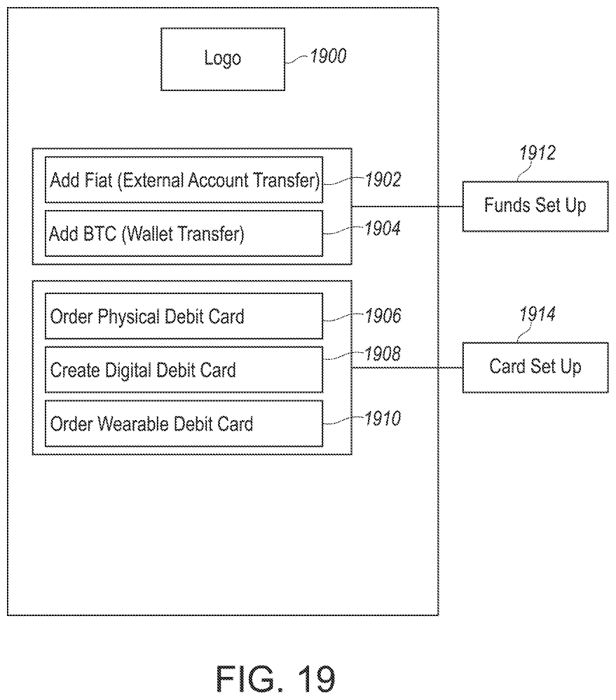

FIG. 18 provides an example of a page of a user interface for an application of a client device capable of interacting with the platform, as described herein. In this example embodiment, the user may see a logo 1800, such as a bank logo, and be provided with an option for adding funds 1802 or cryptocurrency to the user's account or wallet. For example, the user may instruct the bank to withdraw funds from a saving account located at another financial institution and add the funds to the user's account at the bank. In another example, the user may instruct a third-party financier (or a wallet holder and/or exchange) to add funds to the user's cryptocurrency wallet in exchange for a US dollar withdrawal from the user's account. In another example, the user may facilitate a wallet-to-wallet transfer using this option. This may be from another wallet the user owns at a different exchange, for example, or from another individual who has a cryptocurrency wallet and wants to transfer cryptocurrency directly to a user. The page may have a button that enables the user to receive access to previous payments posted on the account 1804. The payments may include both fiat currency payments and cryptocurrency payments. The user may also facilitate various payment transactions using various assets, such as fiat currency or cryptocurrency 1810, and indicating the party(ies) to be charged 1806 and the associated amounts to be charged 1808.

FIG. 19 shows an example of a page of a user interface for an application of a client device capable of interacting with the platform, as described herein. In this example embodiment, the user the user may see a logo 1900, such as a bank logo, and may be provided with an option for funding the user's accounts 1912. For example, the user may add fiat currency 1902 to the user's checking account by using an external account transfer. As another example, the user may add a cryptocurrency 1904 to the user's wallet, such as using a wallet-to-wallet transfer. The user may be provided with a link to set up a card associated with their account 1914, and options to order a physical care 1906, create a digital debit card 1908, order a wearable debit or credit card 1910, or perform some other type of card set up action. The user may also ask for a replacement card, a digital debit card or order a wearable debit card. The wearable debit card may include an RFID chip. The wearable debit card may be inserted in a ring or other device.

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platforms. A processor may be any kind of computational or processing device capable of executing program instructions, codes, binary instructions and the like, including a central processing unit (CPU), a general processing unit (GPU), a logic board, a chip (e.g., a graphics chip, a video processing chip, a data compression chip, or the like), a chipset, a controller, a system-on-chip (e.g., an RF system on chip, an AI system on chip, a video processing system on chip, or others), an integrated circuit, an application specific integrated circuit (ASIC), a field programmable gate array (FPGA), an approximate computing processor, a quantum computing processor, a parallel computing processor, a neural network processor, or other type of processor. The processor may be or may include a signal processor, digital processor, data processor, embedded processor, microprocessor or any variant such as a co-processor (math co-processor, graphic co-processor, communication co-processor, video co-processor, AI co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, network-attached storage, server-based storage, and the like.

A processor may include one or more cores that may enhance speed and performance of a multiprocessor. In embodiments, the process may be a dual core processor, quad core processors, other chip-level multiprocessor and the like that combine two or more independent cores (sometimes called a die).

The methods and systems described herein may be deployed in part or in whole through a machine that executes computer software on a server, client, firewall, gateway, hub, router, switch, infrastructure-as-a-service, platform-as-a-service, or other such computer and/or networking hardware or system. The software may be associated with a server that may include a file server, print server, domain server, internet server, intranet server, cloud server, infrastructure-as-a-service server, platform-as-a-service server, web server, and other variants such as secondary server, host server, distributed server, failover server, backup server, server farm, and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for the execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network with multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, 5G, LTE, EVDO, mesh, or other network types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like. These devices may include, apart from other components, a storage medium such as flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, network-attached storage, network storage, NVME-accessible storage, PCIE connected storage, distributed storage, and the like.

The methods and systems described herein may transform physical and/or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable code using a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices, artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions. Computer software may employ virtualization, virtual machines, containers, dock facilities, portainers, and other capabilities.

Thus, in one aspect, methods described above and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “with,” “including,” and “containing” are to be construed as open-ended terms (i.e., meaning “including, but not limited to,”) unless otherwise noted. Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. The term “set” may include a set with a single member. No language in the specification should be construed as indicating any non-claimed element as essential to the practice of the disclosure.

While the foregoing written description enables one skilled to make and use what is considered presently to be the best mode thereof, those skilled in the art will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

All documents referenced herein are hereby incorporated by reference as if fully set forth herein.

1-13. (canceled)

14. A method for configuring and initiating a cryptocurrency payment and distribution platform, comprising:
identifying, by a processing system having one or more processors, a fiat account associated with a user; wherein the account is controlled by a financial service provider;
identifying, by the processing system, a cryptocurrency wallet associated with a user; wherein the wallet is controlled by the platform;
identifying, by the processing system, a cryptocurrency valuation;
identifying, by the processing system, a fiat currency valuation;
receiving, by the processing system, a request for payment from an entity;
wherein the payment is for a product or service associated with the entity;
withdrawing, by the processing system, a cryptocurrency amount from the wallet;
wherein the cryptocurrency amount corresponds to the request for payment based on the cryptocurrency valuation;
exchanging, by the processing system, the cryptocurrency amount for a fiat currency amount corresponding value of; and
transferring the fiat currency amount to the entity to satisfy the request for payment.

15. The method of claim 15, wherein the financial service provider is a bank.

16. The method of claim 15, wherein the financial service provider is a credit card company.

17. The method of claim 15, wherein the exchange is automatically performed by the cryptocurrency payment and distribution platform based at least in a part on a rule stored in a smart contract.

18. The method of claim 17, wherein the rule relates to a minimum cryptocurrency valuation to be met prior to making the exchange.

19-35. (canceled)
